(19) United States
(12) Patent Application Publication
(10) Pub. No.: US 2010/0135640 A1
(43) Pub. Date: Jun. 3, 2010

(54) System and Method for Storing and Displaying 3-D Video Content

(75) Inventors: Brian Zucker, Austin, TX (US); Thomas Alexander Shows, Leander, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/327,089

(22) Filed: Dec. 3, 2008

(51) Int. Cl. H04N 5/91

(52) U.S. Cl. 386/95; 386/E05.064

(57) ABSTRACT

Systems and methods for reducing problems and disadvantages associated with storing and displaying three-dimensional video content are disclosed. An article of manufacture may include a computer readable medium and data carried on the computer readable medium. The data may be readable by a processor and may including a first content stream including data representing a video at a first viewing perspective and at a first resolution and a second content stream including data representing the video at a second viewing perspective different from the first viewing perspective and at a second resolution lower than the first resolution. The second content stream and a portion of the first content stream may be read and processed by the processor to display the video to a display device such that the video may be viewed at the first resolution as a three-dimensional video.

### TECHNICAL FIELD

The present disclosure relates in general to display of video content, and more particularly to storing and displaying three-dimensional video content.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are often used in the entertainment industry. As a specific example, optical media has often been used to store audio and visual information. For instance, Compact Disc (CD) optical media, which interact with an infrared laser to store and read information, are commonly used to store music and/or other data. Similarly, DVD optical media, which interact with a red laser to store and read information, are commonly used to store movies for commercial sale, as well as other data. Recently, a new type of optical medium has been developed that uses a blue laser to read and write information, such as with the Blu-ray Disc (BD) or High Definition DVD specifications, for example. One advantage of blue laser media is that the smaller wavelength of the blue laser compared with the infrared and red lasers allows greater storage density for blue laser optical media.

Video content, including video content stored on optical media, often utilizes three-dimensional (3-D) imaging, also known as stereoscopy and stereoscopic imaging. 3-D imaging may be any technique capable of recording three-dimensional visual information or creating the illusion of depth in an image. For example, the illusion of depth in a photograph, video, or other two-dimensional image may be created by presenting a slightly different two-dimensional image to each eye of a viewer. In order to create an illusion of depth, each two-dimensional image may represent two perspectives of the same object or scene, with a minor deviation similar to the perspective that both eyes may naturally receive in binocular vision. In order to display video content in three-dimensions, two two-dimensional images may be superimposed onto each other on a single screen or display. A viewer may wear specially-adapted glasses, wherein each lens of the glasses includes a polarizer and/or filter allowing the user to see one of the two images in one eye, and the other of the two images in the other eye, thus creating the illusion of depth.

Recently, three-dimensional theatrical content has grown in popularity, and content providers are increasing the number of films produced in using 3-D content. Such content providers may desire to include such 3-D content on the same media that similar content is provided in 2-D (e.g., a movie studio may want to distribute a Blu-Ray Disc including both a two-dimensional version of a film and a three-dimensional version of the same film). However, because of storage limitations inherent in storage media (e.g., optical media), storing both 2-D and 3-D streams on the same storage medium may prove difficult, especially if both streams are to be provided at full resolution.

### SUMMARY

In accordance with the teachings of the present disclosure, the disadvantages and problems associated with storing and displaying three-dimensional video content have been substantially reduced or eliminated.

In accordance with one embodiment of the present disclosure, an article of manufacture may include a computer readable medium and data carried on the computer readable medium. The data may be readable by a processor and may including a first content stream including data representing a video at a first viewing perspective and at a first resolution and a second content stream including data representing the video at a second viewing perspective different from the first viewing perspective and at a second resolution lower than the first resolution. The second content stream and a portion of the first content stream may be read and processed by the processor to display the video to a display device such that the video may be viewed at the first resolution as a three-dimensional video.

In accordance with yet another embodiment of the present disclosure, an information handling system may include a processor, a memory communicatively coupled to the processor, and computer-executable instructions carried on a computer readable medium. The instructions may be executable by the one or more processors to: (i) read a first content stream from an optical medium, the first content stream including data representing a video at a first viewing perspective and at a first resolution; (ii) read a second content stream from the optical medium, the second content stream including data representing the video at a second viewing perspective different from the first viewing perspective and at a second resolution lower than the first resolution; and (iii) communicate instructions to a display device to display the second content stream and a portion of the first content stream such that the video may be viewed at the first resolution as a three-dimensional video.

In accordance with yet another embodiment of the present disclosure, a method for processing video content may include reading a first content stream from an optical medium, the first content stream including data representing a video at a first viewing perspective and at a first resolution. The method may also include reading a second content stream from the optical medium, the second content stream including data representing the video at a second viewing perspective different from the first viewing perspective and at a second resolution lower than the first resolution. The method may further include communicating instructions to a display device to display the second content stream and a portion of the first content stream such that the video appears to a viewer at the first resolution as a three-dimensional video.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for downloading content associated with optical media, in accordance with certain embodiments of the present disclosure;

FIG. 2 illustrates a block diagram of certain content that may be stored on an optical medium, in accordance with certain embodiments of the present disclosure;

FIG. 3A illustrates a display device in a two-dimensional playback mode of the information handling system depicted in FIG. 1; and

FIG. 3B illustrates a display device in a three-dimensional playback mode of the information handling system depicted in FIG. 1.

### DETAILED DESCRIPTION

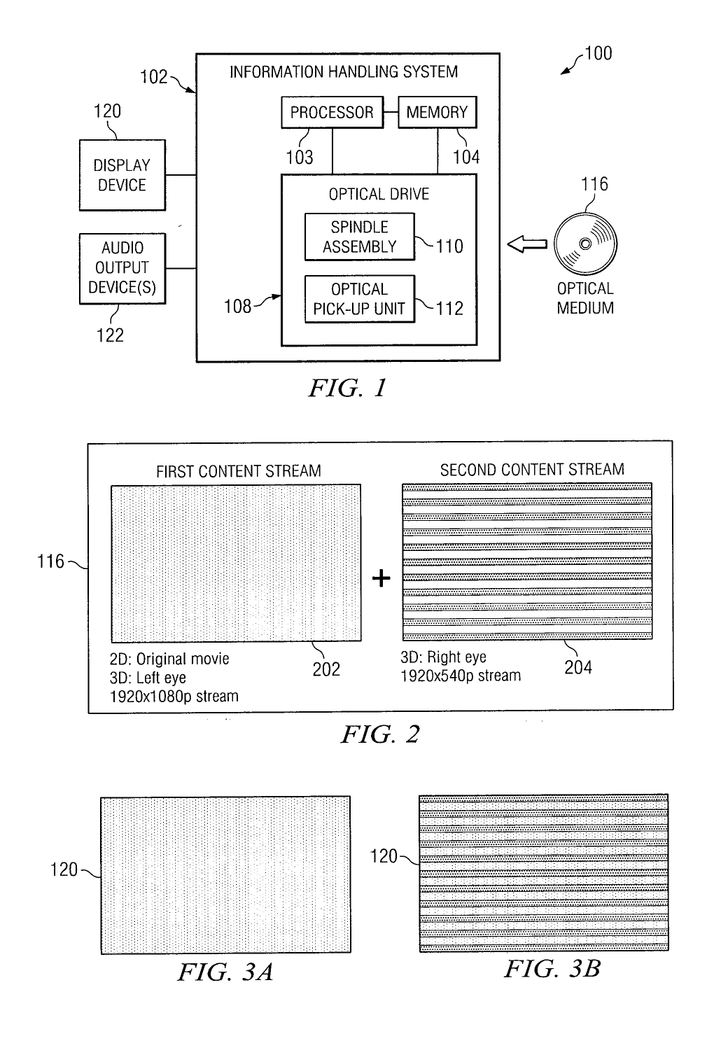

Preferred embodiments and their advantages are best understood by reference to FIGS. 1-3B, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example system 100 for downloading content associated with optical media. As depicted in FIG. 1, system 100 may comprise an information handling system 102, an optical medium 116, a display 120, and one or more audio output devices 122.

Information handling system 102 may generally be configured to read data from one or more optical media 116 received in optical drive 108 and process such data for display on display device 120 and/or output to audio output device(s) 122. In certain embodiments, information handling system 102 may be a computer, such as a desktop computer or portable computer (e.g., a “laptop” or “notebook”), for example. In other embodiments, information handling system 102 may be a optical media player, e.g. a Blu-ray Disc player or High Definition DVD player.

As depicted in FIG. 1, information handling system 102 may comprise a processor 103, a memory 104 communicatively coupled to processor 103, a network interface 106 communicatively coupled to processor 103, and an optical drive 108 coupled to processor 103 and/or memory 104.

Processor 103 may comprise any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, optical drive 108 and/or another component of information handling system 102.

Memory 104 may be communicatively coupled to processor 103 and may comprise any system, device, or apparatus configured to retain program instructions or data for a period of time (e.g., computer-readable media). Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

Optical drive 108 may be any suitable system, apparatus, or device configured to read data from and/or write data to an optical storage medium such as optical medium 116, for example. In certain embodiments, optical drive 108 may use laser light or other electromagnetic energy to read and/or write data to an optical medium. As depicted in FIG. 1, optical drive 108 may include spindle assembly 110 and optical pick-up unit 112. Spindle assembly 110 may be any suitable system, apparatus, or device configured to spin optical medium 116 proximate to optical pick-up unit 112. Optical pick-up unit 112 may include a laser or other source of electromagnetic energy (e.g., a blue laser for interacting with Blu-ray Disc media) which may illuminate optical medium 116 to read information stored on optical medium 116 and/or write information to optical medium 116. Information read from optical medium 116 may be processed within optical drive 108, processor 103, and/or another component of information handling system 102 to produce audio and/or display signals (e.g., for output to display device 120 and/or audio output device(s) 122) representing the information stored on optical medium 116.

Optical medium 116 may include any system, apparatus, or device that may retain data and/or instructions for a period of time, wherein data and/or instructions may be read from and/or written to optical medium 116 by use of a laser or other source of electromagnetic energy. In certain embodiments, optical medium 116 may include a flat, circular disc (an optical disc, such as a CD, DVD, or blue laser medium, for example) wherein data is stored in the “pits” or “bumps” in the flat surface, such that the pits may distort incident laser light.

Display device 120 may include any system, apparatus, or device suitable for creating graphic images and/or alphanumeric characters recognizable to a user, and may include, for example, a liquid crystal display (LCD), cathode ray tube (CRT), a plasma screen, and a digital light processor (DLP) projection monitor. In certain embodiments, display device 120 may include a computer monitor. In other embodiments, display device 120 may include a television.

Audio output device(s) 122 may include any system, apparatus, or device suitable for outputting sound signals generated by information handling system 102, for example, music, soundtracks, and/or sounds stored on optical medium 116. In certain embodiments, audio output device(s) 122 may include one or more speakers and an audio driver operable to control the one or more speakers. Audio output device 122 may include any suitable type of speaker, such as a cone or ribbon-based loudspeaker, for example. Audio output device 122 may comprise any audio driver or other program or device that controls the operation of a speaker. The audio driver may act as a translator between processor 102 and audio output device 122.

FIG. 2 illustrates a block diagram of certain content that may be stored on optical medium 116, in accordance with certain embodiments of the present disclosure. As depicted in FIG. 2, optical medium 116 may include, among other things, a first content stream 202 and a second content stream 204. First content stream 202 may include data representing a video at a first perspective and at a first resolution. Second content stream 204 may include data representing the video at a second perspective different from the first perspective and at a second resolution lower than the first resolution. In some embodiments, the second resolution may be approximately one-half of the first resolution. In the same or alternative embodiments, first content stream 202 may include video associated with a viewer's left eye and second content stream 204 may include video associated with the viewer's right eye, or vice versa.

FIG. 3A illustrates display device 120 in a two-dimensional viewing mode of information handling system 102. As depicted in FIG. 3A, in a two-dimensional viewing mode, information handling system 102 may read and process first content stream 202 from optical medium 116, and display first content stream 202 on display 120 at the first resolution.

FIG. 3B illustrates display device 120 in a three-dimensional viewing mode of information handling system 102. As depicted in FIG. 3B, in a three-dimensional viewing mode, information handling system 102 may read and process each of first content stream 202 and second content stream 204, and may display a portion of first content stream 202 combined with second content stream 204, such that the combined content stream is displayed at the first resolution. In some embodiments, the portion of first content stream 202 displayed may include alternating lines of first content stream 202 complementary to lines of second content stream 204. Accordingly, because first content stream 202 and second content stream 204 are from different perspectives, the display device may display a video at the first resolution that when properly viewed (e.g., using polarizers and/or filters) appears to be in three dimensions.

As a specific example, optical medium 116 may comprise a Blu-ray Disc for a motion picture, wherein first content stream 202 represents the motion picture at a first perspective at full resolution (e.g., 1920×1080 p) and second content stream 204 represents the motion picture at a second perspective at half resolution (e.g., 1920×540 p). If optical medium 106 is played in a two-dimensional viewing mode (e.g., a viewer selects a two-dimensional viewing mode and/or information handling system 102 does not include a three-dimensional viewing mode), first content stream 202 may be displayed to display device 120 at full resolution. On the other hand, if optical medium 106 is played in a three-dimensional viewing mode (e.g., a viewer selects a three-dimensional viewing mode and/or information handling system 102 supports a three-dimensional viewing mode), second content stream 204 and the half of first content stream 202 complementary to second content stream 204 may be displayed to display device 120 to create a three-dimensional image at full resolution.

Using the methods and systems disclosed herein, problems associated with conventional approaches to storing and displaying 3-D video content may be improved, reduced, or eliminated. For example, methods and systems disclosed herein may allow for the storage of full-resolution two-dimensional content and associated full-resolution three-dimensional content on the same optical medium, without requiring the storage capacity of an entire full-resolution two-dimensional content stream and an entire full-resolution three-dimensional content stream, as is often required pursuant to traditional approaches.

Although the present disclosure has been described in detail, it should be understood that various changes, substitutions, and alterations can be made hereto without departing from the spirit and the scope of the disclosure as defined by the appended claims.

What is claimed is:

1. An article of manufacture comprising:
a computer readable medium; and
data carried on the computer readable medium, the data readable by a processor and including:
a first content stream including data representing a video at a first viewing perspective and at a first resolution; and
a second content stream including data representing the video at a second viewing perspective different from the first viewing perspective and at a second resolution lower than the first resolution;
wherein the second content stream and a portion of the first content stream may be read and processed by the processor to display the video to a display device such that the video may be viewed at the first resolution as a three-dimensional video.

2. An article of manufacture according to claim 1, wherein the second resolution is approximately one-half of the first resolution.

3. An article of manufacture according to claim 1, wherein the portion of the first content stream includes alternating lines of the first content stream complementary to lines of the second content stream.

4. An article of manufacture according to claim 1, wherein the first viewing perspective is associated with one of a left-eye viewing perspective and a right-eye viewing perspective of a viewer and the second viewing perspective is associated with the other of the left-eye viewing perspective and the right-eye viewing perspective.

5. An article of manufacture according to claim 1, wherein the computer readable medium is an optical medium.

6. An article of manufacture according to claim 1, wherein the computer readable medium is a Blu-ray Disc.

7. An article manufacture according to claim 1, wherein the first content stream may be read and processed by the processor to display the video to a display device such that the video may be viewed at the first resolution as a two-dimensional video.

8. An information handling system comprising:
a processor;
a memory communicatively coupled to the processor; and
computer-executable instructions carried on a computer readable medium, the instructions executable by the one or more processors to:
read a first content stream from an optical medium, the first content stream including data representing a video at a first viewing perspective and at a first resolution;
read a second content stream from the optical medium, the second content stream including data representing the video at a second viewing perspective different from the first viewing perspective and at a second resolution lower than the first resolution; and
communicate instructions to a display device to display the second content stream and a portion of the first content stream such that the video may be viewed at the first resolution as a three-dimensional video.

9. An information handling system according to claim 1, wherein the second resolution is approximately one-half of the first resolution.

10. An information handling system according to claim 1, wherein the portion of the first content stream includes alternating lines of the first content stream complementary to lines of the second content stream.

11. An information handling system according to claim 8, wherein the first viewing perspective is associated with one of a left-eye viewing perspective and a right-eye viewing perspective of a viewer and the second viewing perspective is associated with the other of the left-eye viewing perspective and the right-eye viewing perspective.

12. An information handling system according to claim 8, wherein the optical medium is a Blu-ray Disc.

13. An information handling system according to claim 8, the computer-readable instructions further operable to communicate instructions to the display device to display the first content stream such that the video appears to a viewer at the first resolution as a two-dimensional video.

14. A method for processing video content, comprising:
reading a first content stream from an optical medium, the first content stream including data representing a video at a first viewing perspective and at a first resolution;
reading a second content stream from the optical medium, the second content stream including data representing the video at a second viewing perspective different from the first viewing perspective and at a second resolution lower than the first resolution; and
communicating instructions to a display device to display the second content stream and a portion of the first content stream such that the video appears to a viewer at the first resolution as a three-dimensional video.

15. A method according to claim 14, wherein the second resolution is approximately one-half of the first resolution.

16. A method according to claim 14, wherein the portion of the first content stream includes alternating lines of the first content stream complementary to lines of the second content stream.

17. A method according to claim 14, wherein the first viewing perspective is associated with a left-eye viewing perspective of a viewer and the second viewing perspective is associated with a right-eye viewing perspective of the viewer.

18. A method according to claim 14, wherein the first viewing perspective is associated with a right-eye viewing perspective of a viewer and the second viewing perspective is associated with a left-eye viewing perspective of the viewer.

19. A method according to claim 14, wherein the optical medium is a Blu-ray Disc.

20. A method according to claim 14, further comprising communicating instructions to the display device to display the first content stream such that the video appears to a viewer at the first resolution as a two-dimensional video.
